(19) United States
(12) Patent Application Publication
(10) Pub. No.: US 2014/0085219 A1
(43) Pub. Date: Mar. 27, 2014

(54) CONTROLLING DISPLAY DEVICE WITH DISPLAY PORTIONS THROUGH TOUCH-SENSITIVE DISPLAY

(71) Applicants: YI-WEN CAI, Tu-Cheng (TW); CHUN-MING CHEN, Tu-Cheng (TW); CHUNG-I LEE, Tu-Cheng (TW)

(72) Inventors: YI-WEN CAI, Tu-Cheng (TW); CHUN-MING CHEN, Tu-Cheng (TW); CHUNG-I LEE, Tu-Cheng (TW)

(21) Appl. No.: 13/652,518

(22) Filed: Oct. 16, 2012

(30) Foreign Application Priority Data
Sep. 26, 2012 (TW) 101135437

(51) Int. Cl. G06F 3/041

(52) U.S. Cl. 345/173

(57) ABSTRACT

A display device with a plurality of display portions; each display portion being a television or areas of a screen of a television. The display device can be controlled by a control device such as a portable device which includes a touch-sensitive display unit and a control unit. The touch-sensitive display unit displays a graphic user interface (GUI) corresponding to the display device. The control unit produces operation parameter(s) according to touch operation(s) on the touch-sensitive display unit and transmits the operation parameter(s) to the display device, thereby enabling the display device to modify image(s) actually displayed, by changing the position or the size of the image(s) actually displayed, according to the operation parameter(s).

### BACKGROUND

1. Technical Field

The present disclosure relates to a display system, and particularly to a display system capable of controlling a display device with a plurality of display portions through a touch-sensitive display on a control device such as a portable device.

2. Description of Related Art

Display walls are often used where larger display screens are required because of their characteristics such as high-definition and easy-installation. Portable devices such as smart phones and tablet computers are popular because of their characteristics such as portability and easy operation. Consequently, the portable devices are increasingly used to interact with other types of devices. However, the control of display walls is never implemented through portable devices.

Thus, there is room for improvement in the art.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a display system of the present disclosure.

FIG. 2 is a schematic view of an embodiment of the GUI displayed through the touch-sensitive display unit of the control device of FIG. 1.

FIG. 3 is a flowchart of an embodiment of a display control method implemented through the display system of FIG. 1.

FIG. 4A/4B is a schematic view of a first embodiment of a process of using the GUI of FIG. 2.

FIG. 5A/5B is a schematic view of a second embodiment of a process of using the GUI of FIG. 2.

FIG. 6A/6B is a schematic view of a third embodiment of a process of using the GUI of FIG. 2.

### DETAILED DESCRIPTION

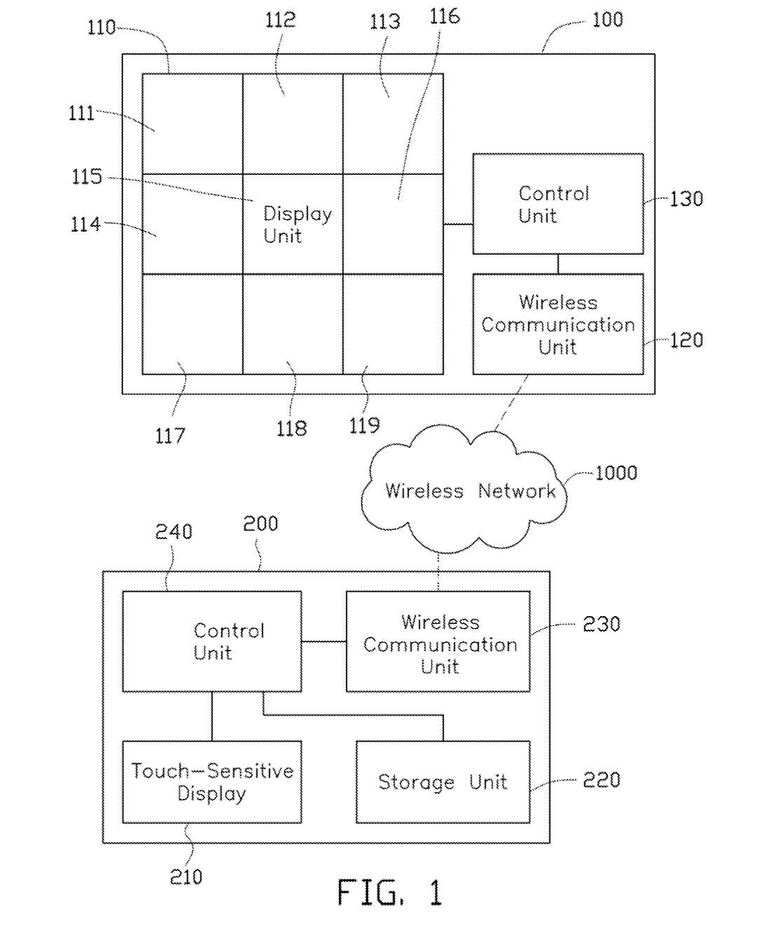

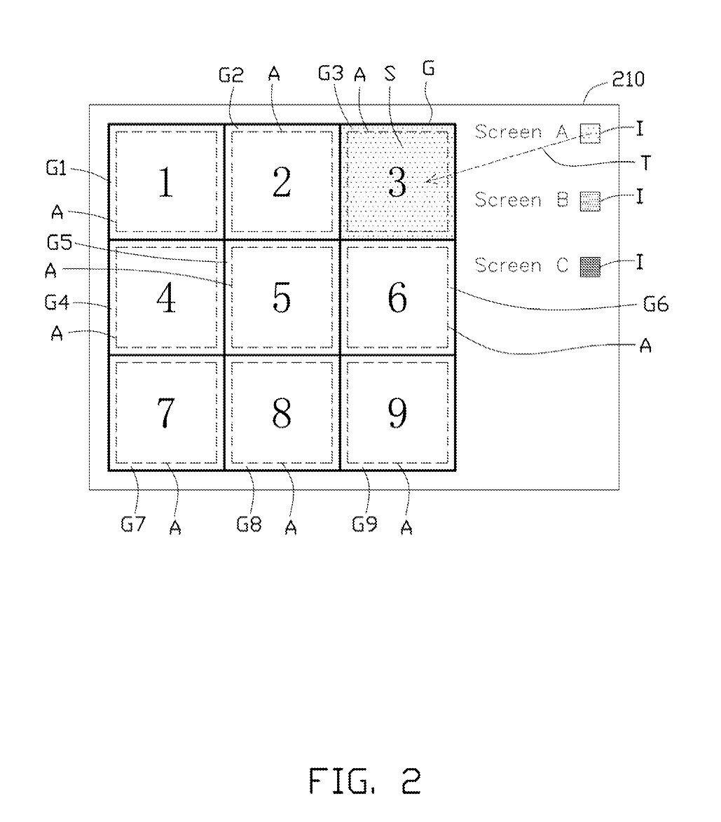

FIG. 1 is a block diagram of an embodiment of a display system of the present disclosure. The display system includes a display device 100 and a control device 200. The display device 100 includes a display unit 110 with display portions 111-119, a wireless communication unit 120, and a control unit 130. In the illustrated embodiment, the display unit 110 is a display wall while each of the display portions 111-119 is an individual display device such as a television. In other illustrated embodiments, the display unit 110 can be a display such as a single television while each of the display portions 111-119 is an area of a screen of the display unit 110. The wireless communication unit 120 communicates with the control device 200 through a wireless network 1000 such as a short distance wireless network implemented according to, for example, BLUETOOTH telecommunication standard. The control unit 130 which may include graphics card(s) controls the display unit 110 to display image(s) individually through only one of the display portions 111-119, or display image(s) jointly through a plurality or all of the display portions 111-119. The control unit 130 can further modify the image(s) displayed on the display unit 110 by, for instance, changing the screen-position or the size of the image(s), according to operation parameter(s) P (not shown) received from the control device 200.

The control device 200 includes a touch-sensitive display unit 210, a storage unit 220, a wireless communication unit 230, and a control unit 240. The touch-sensitive display unit 210 may include a touch-sensitive display (touchscreen) which displays a graphical user interface (GUI) G (see FIG. 2) corresponding to the display device 100. The control unit 240 controls the touch-sensitive display unit 210 to display the GUI G according to an application software with instructions for displaying the GUI G which is stored in the storage unit 220 and executed by the control unit 240. The control unit 240 further produces the operation parameter(s) P such as the coordinates of the touch operation(s) on the touch-sensitive display unit 210 or instructions for controlling the display unit 110 according to touch operation(s) on the touch-sensitive display unit 210, and transmits the operation parameter(s) P to the display device 100 through the wireless communication unit 230, wherein the touch operation is a contact with touch-sensitive display unit 210 which corresponds to predefined gestures such as finger-sliding, finger-spreading, or finger-pinching on the touch-sensitive display unit 210.

The GUI G allows a user to perform the touch operation(s) on the touch-sensitive display unit 210. In the illustrated embodiment, the control device 200 is a portable device such as a smart phone or a tablet computer which communicates with the display device 100 through the wireless network 1000. In other embodiments, the control device 200 can be a fixed device communicating with the display device 100 through a wire such as a category 5 cable.

FIG. 2 is a schematic view of an embodiment of the GUI G displayed through the touch-sensitive display unit 210 of the control device 200 of FIG. 1. The GUI G includes blocks G1-G9 arranged according to the layout of the display portions 111-119 in the display device 100, such that the blocks G 1-G9 correspond to the display portions 111-119, respectively. The touch-sensitive display unit 210 can display image symbol(s) S, wherein each of the image symbol(s) S is a graphical, interactive user-interface object-image such as an icon to represent the location of one of the images displayed by the display unit 110 of the display device 100. The image symbol(s) S are modified according to the operation parameter(s) P, thereby corresponding to the modification of the image(s) displayed on the display unit 110.

In the illustrated embodiment, each of the blocks G1-G9 corresponds to a display portion 111-119. In other embodiments, a plurality of blocks can correspond to each of the display portions 111-119. The touch-sensitive display unit 210 includes responsive areas A, each responsive area A corresponding to one of the blocks G1-G9. The responsive area A is a virtual area defined through software. The image(s) displayed on the display unit 110 are chosen by dragging a symbol such as an icon or a label to one of the blocks G1-G9. For instance, icon I can be dragged to one of the blocks G1-G9 along a track T to choose the image(s), wherein the icon I is a graphical, interactive user-interface object-image to represent a signal source such as a television channel which provides its own information for displaying the image(s).

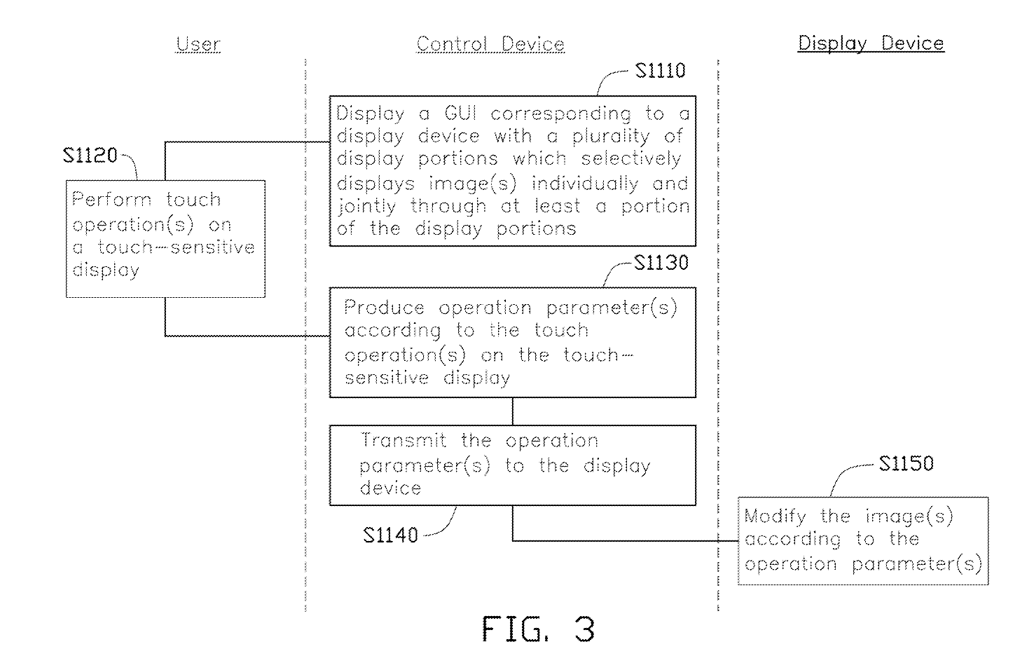

FIG. 3 is a flowchart of an embodiment of a display control method implemented through the display system of FIG. 1. The display control method of the present disclosure is as follows; steps S1110 and S1130-S1140 are implemented through instructions stored in the storage unit 220 of the control device 200. Depending on the embodiment, additional steps may be added, others removed, and the ordering of the steps may be changed.

In step S1110, the GUI G corresponding to the display device 110 with the display portions 111-119 is displayed, wherein the display device 110 displays image(s) individually through only one of the display portions 111-119, or displays image(s) jointly through a plurality or all of the display portions 111-119. In the illustrated embodiment, the GUI includes the blocks G1-G9 arranged to correspond to the layout of the display portions 111-119 in the display device 100, such that each of the blocks G1-G9 corresponds to one of the display portions 111-119 (see FIG. 2).

In step S1120, the touch operation(s) are performed on the touch-sensitive display unit 210 by a user.

In step S1130, the operation parameter(s) P are produced according to the touch operation(s) on the touch-sensitive display unit 210.

In step S 1140, the operation parameter(s) P are transmitted to the display device 100.

In step S1150, the image(s) are modified according to the operation parameter(s) P by the display device 100.

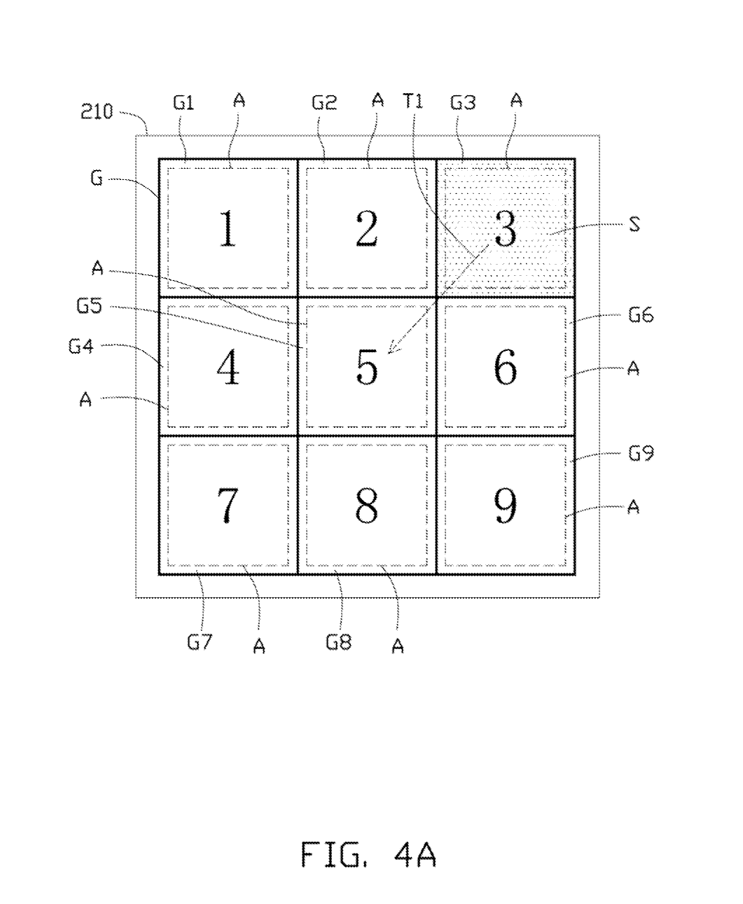

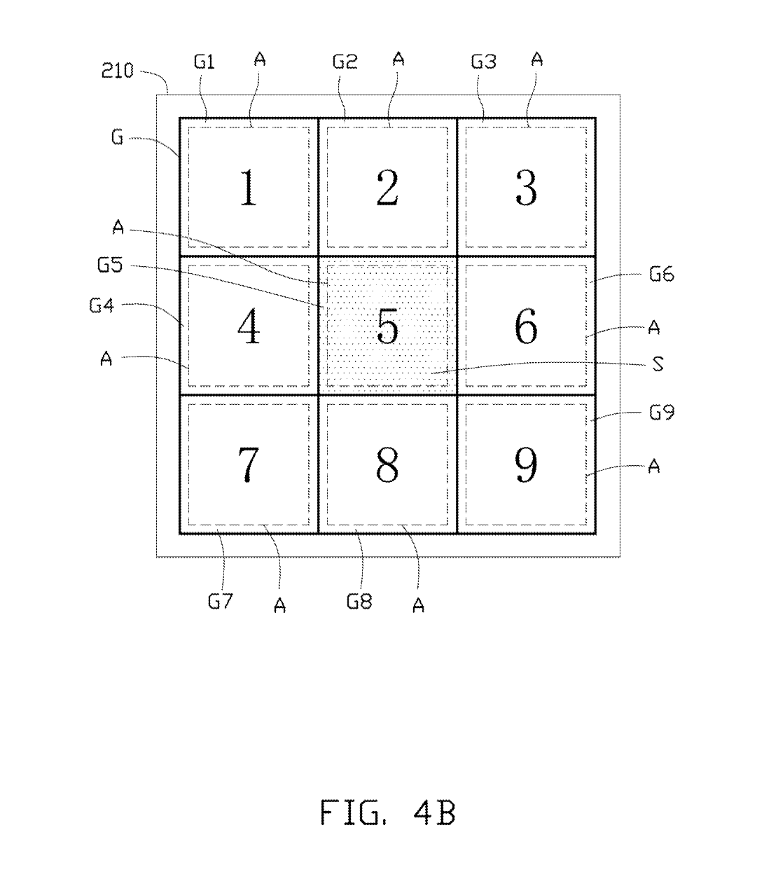

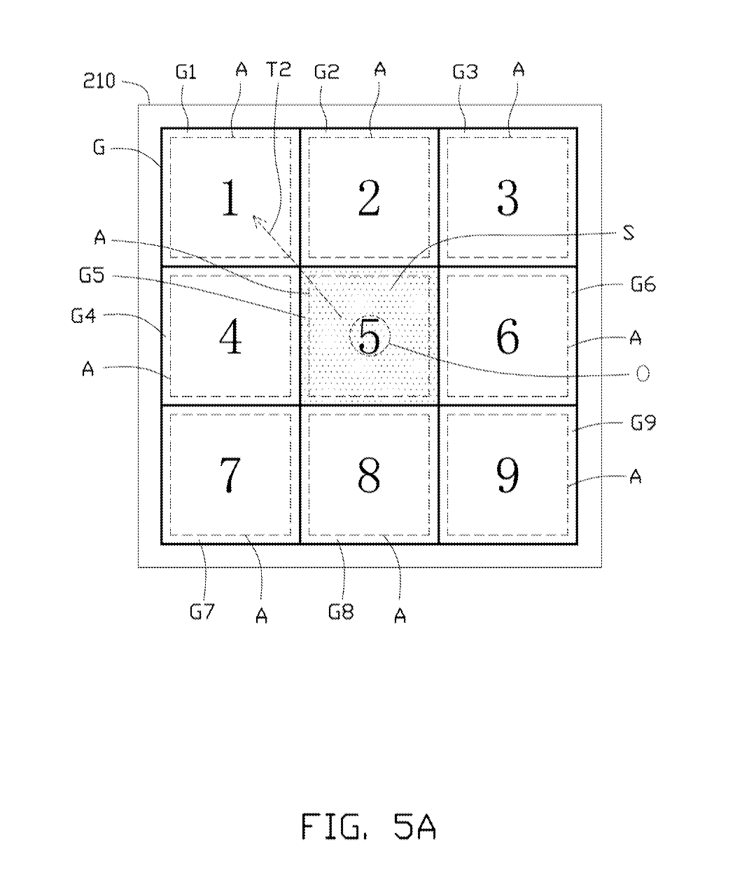

FIG. 4A/4B is a schematic view of a first embodiment of a process of using the GUI G of FIG. 2. The display device 100 modifies the image(s) by changing the position(s) of the image(s) on the display portions 111-119. The operation parameter(s) P are produced according to the touch operation(s) on the touch-sensitive display unit 210 while the touch operation(s) are performed on the touch-sensitive display unit 210 by a user. When the operation parameter(s) P correspond to the touch operation(s) extending across adjacent responsive areas A along track(s) of a direction, the operation parameter(s) P are transmitted to the display device 100, thereby enabling the display device 100 to change the position of the image(s) according to the direction. For instance, when a sliding contact is performed across the responsive area A corresponding to the block G3 and the responsive area A corresponding to the block G5 along a track T1 of a direction from the block G3 to the block G5, the image symbol S will be moved from the block G3 to the block G5 while the image corresponding to the image symbol S will be moved from the display 113 to the display 115.

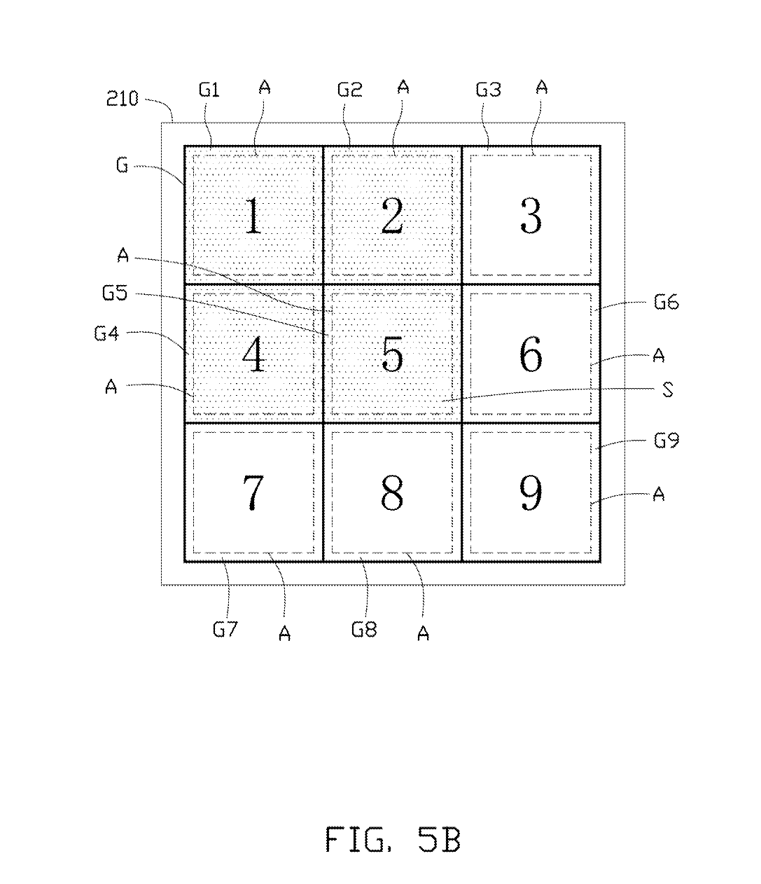

FIG. 5A/5B is a schematic view of a second embodiment of a process of using the GUI G of FIG. 2. The display device 100 modifies the image(s) by changing the size of the image(s) on the display portions 111-119. When the operation parameter(s) P correspond to a finger-spreading operation which one of the touch operations extends across adjacent responsive areas A along a track of a direction while another of the touch operations is fixed within the responsive area A, the operation parameter(s) P are transmitted to the display device 100, thereby enabling the display device 100 to change the size of the image(s) according to the direction. In the illustrated embodiment, the size of the image(s) and the image symbol S are changed according to the ratio of the length of the original image to the width of the original image.

For instance, when a sliding contact is performed across the responsive area A corresponding to the block G5 and the responsive area A corresponding to the block G1 along a track T2 of a direction from the block G5 to the block G1, while another contact is performed at a point O within the responsive area A corresponding to the block G5, the image symbol S will be expanded to the block G1-G2, and G4 while the image corresponding to the image symbol S will be expanded to the display portions 111-112, and 114. When a sliding contact is performed across the responsive area A corresponding to the block G1 and the responsive area A corresponding to the block G5 along a track of a direction from the block G1 to the block G5, while another contact is performed at a point within the responsive area A corresponding to the block G5, the image symbol S will be shrunk to the block G5 while the image corresponding to the image symbol S will be shrunk to the display 115.

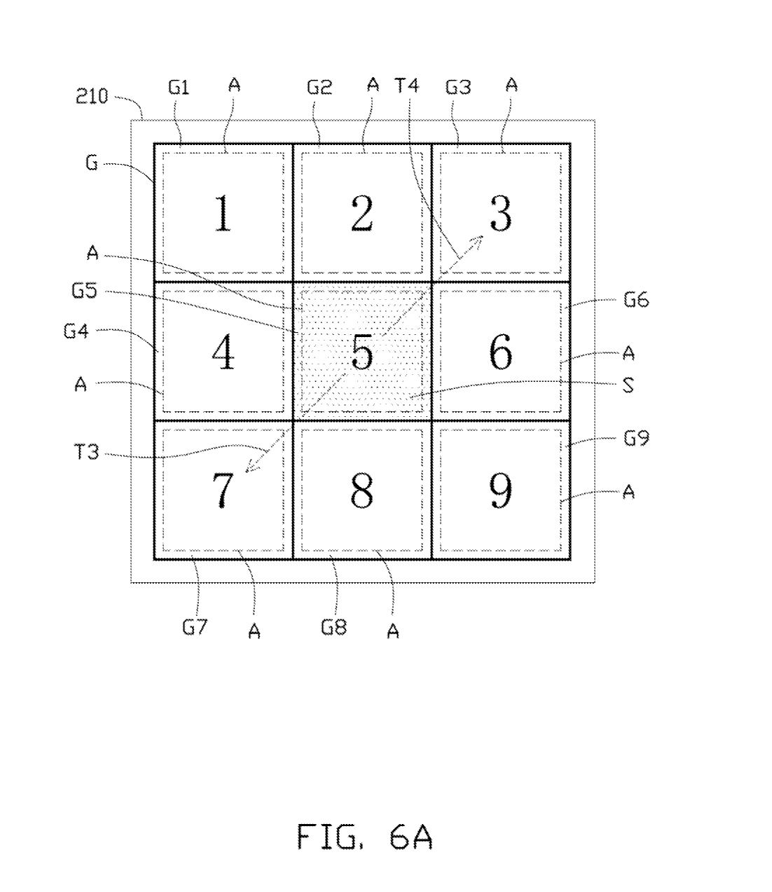

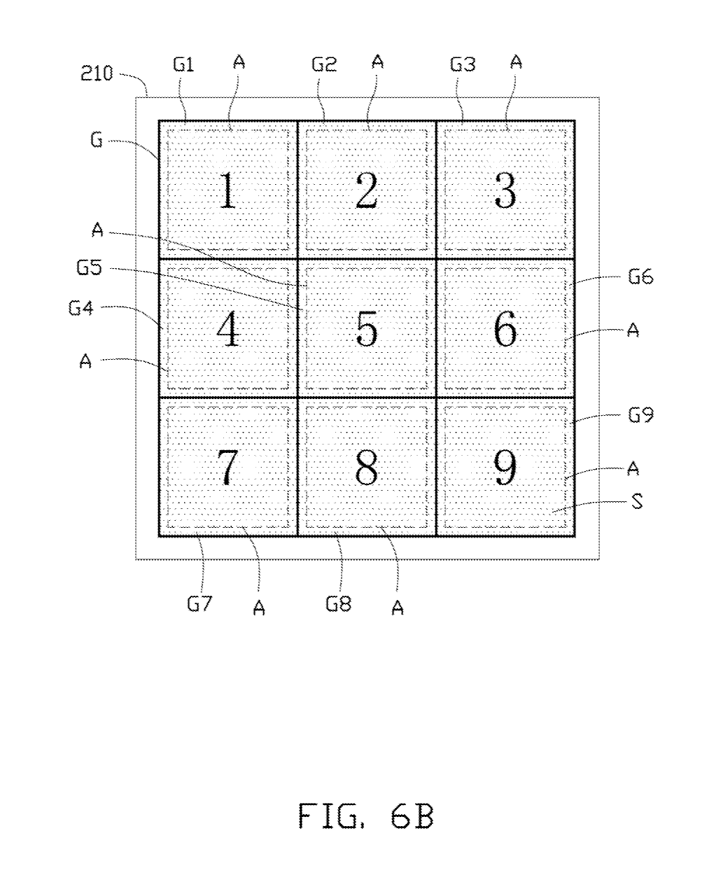

FIG. 6A/6B is a schematic view of a third embodiment of a process of using the GUI G of FIG. 2. In the illustrated embodiment, the display device 100 modifies the image(s) by changing the size of the image(s) on the display portions 111-119. When the operation parameter(s) P correspond to a finger-spreading operation which one of the touch operations extends across adjacent responsive areas A along a first track of a first direction while another of the touch operations extends across adjacent responsive areas A along a second track of a second direction, the operation parameter(s) P are transmitted to the display device 100, thereby enabling the display device 100 to change the size of the image(s) according to the first direction and the second direction. In the illustrated embodiment, the size of the image(s) and the image symbol S are changed according to the ratio of the length of the original image to the width of the original image.

For instance, when a sliding contact is performed across the responsive area A corresponding to the block G5 and the responsive area A corresponding to the block G3 along a track T3 of a direction from the block G5 to the block G3, while another sliding contact is performed across the responsive area A corresponding to the block G5 and the responsive area A corresponding to the block G7 along a track T4 of a direction from the block G5 to the block G7, the image symbol S will be expanded to the block G1-G4 and G6-G9 while the image corresponding to the image symbol S will be expanded to the display portions 111-114 and 116-119. When a sliding contact is performed across the responsive area A corresponding to the block G3 and the responsive area A corresponding to the block G5 along a track of a direction from the block G3 to the block G5, while another sliding contact is performed across the responsive area A corresponding to the block G7 and the responsive area A corresponding to the block G5 along a track of a direction from the block G7 to the block G5, the image symbol S will be shrunk to the block G5 while the image corresponding to the image symbol S will be shrunk to the display 115.

The display system provides a touch-sensitive display for controlling a display device, wherein the touch-sensitive display can be installed on a fixed device or a portable device such as a smart phone or a tablet computer.

While the disclosure has been described by way of example and in terms of preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. A display system, comprising:
a display device comprising a plurality of display portions, wherein the display device selectively displays one or more images individually and jointly through at least a portion of the display portions and modifies the one or more images according to one or more operation parameters; and
a control device, comprising:
a touch-sensitive display unit displaying a graphical user interface (GUI) corresponding to the display device; and
a control unit producing the one or more operation parameters according to one or more touch operations on the touch-sensitive display unit.

2. The display system of claim 1, wherein each of the display portions comprises one of a display and an area of a screen of a display.

3. The display system of claim 2, wherein the GUI comprises a plurality of blocks arranged corresponding to the layout of the display portions in the display device, one or more of the blocks correspond to a display portion.

4. The display system of claim 3, wherein the display device modifies the one or more images by changing the position of the one or more images on the display portions.

5. The display system of claim 4, wherein the touch-sensitive display unit comprises a plurality of responsive areas each corresponding to one of the blocks, the display device changes the position of the one or more images according to a direction when the one or more operation parameters correspond to the one or more touch operations extending across adjacent responsive areas along one or more tracks of the direction.

6. The display system of claim 3, wherein the display device modifies the one or more images by changing the size of the one or more images on the display portions.

7. The display system of claim 6, wherein the touch-sensitive display unit comprises a plurality of responsive areas each corresponding to one of the blocks, the display device changes the size of the one or more images according to a direction when the one or more operation parameters correspond to one of the touch operations extending across adjacent responsive areas along a track of the direction and another of the touch operations being within the responsive area.

8. The display system of claim 6, wherein the touch-sensitive display unit comprises a plurality of responsive areas each corresponding to one of the blocks, the display device changes the size of the one or more images according to a first direction and a second direction when the one or more operation parameters correspond to one of the touch operations extending across adjacent responsive areas along a first track of the first direction and another of the touch operations extending across adjacent responsive areas along a second track of the second direction.

9. The display system of claim 3, wherein each of the blocks corresponds to a display portion, the GUI comprises one or more image symbols each corresponding to an image, the one or more image symbols are modified according to the one or more operation parameters.

10. The display system of claim 1, wherein the control device is a portable device, the portable device communicates with the display device through a wireless network.

11. A display control method, comprising:
displaying a graphical user interface (GUI) corresponding to a display device with a plurality of display portions and selectively displaying one or more images individually and jointly through at least a portion of the display portions;
producing one or more operation parameters according to one or more touch operations;
transmitting the one or more operation parameters to the display device to enable the display device to modify the one or more images according to the one or more operation parameters.

12. The display control method of claim 11, wherein the step of displaying the GUI comprises:
displaying the GUI comprising a plurality of blocks arranged corresponding to the layout of the display portions in the display device with the display portions and selectively displaying the one or more images individually and jointly through at least a portion of the display portions, such that one or more of the blocks correspond to a display portion.

13. The display control method of claim 12, wherein the step of producing the one or more operation parameters comprises:
producing the one or more operation parameters according to one or more touch operations on a touch-sensitive display unit when the one or more touch operations extend across adjacent responsive areas of the touch-sensitive display unit each corresponding to one of the blocks along one or more tracks of a direction;
the step of transmitting the one or more operation parameters comprises:
transmitting the one or more operation parameters to the display device to enable the display device to change the position of the one or more images according to the direction.

14. The display control method of claim 12, wherein the step of producing the one or more operation parameters comprises:
producing the one or more operation parameters according to one or more touch operations on a touch-sensitive display unit when one of the touch operations extends across adjacent responsive areas of the touch-sensitive display unit each corresponding to one of the blocks along a track of a direction and another of the touch operations is within the responsive area;
the step of transmitting the one or more operation parameters comprises:
transmitting the one or more operation parameters to the display device to enable the display device to change the size of the one or more images according to the direction.

15. The display control method of claim 12, wherein the step of producing the one or more operation parameters comprises:
producing the one or more operation parameters according to one or more touch operations on a touch-sensitive display unit when one of the touch operations extends across adjacent responsive areas of the touch-sensitive display unit each corresponding to one of the blocks along a first track of a first direction and another of the touch operations extends across adjacent responsive areas along a second track of a second direction;
the step of transmitting the one or more operation parameters comprises:
transmitting the one or more operation parameters to the display device to enable the display device to change the size of the one or more images according to the first direction and the second direction.

16. The display control method of claim 12, wherein the step of displaying the GUI comprises:
displaying the GUI comprising the plurality of blocks arranged corresponding to the layout of the display portions in the display device and one or more image symbols, such that each of the blocks corresponds to a display portion and each of the one or more image symbols corresponds to an image.

17. A computer program product comprising a non-transitory computer readable storage medium and an executable computer program mechanism embedded therein, the executable computer program mechanism comprising instructions for:
displaying a graphical user interface (GUI) corresponding to a display device with a plurality of display portions and selectively displaying one or more images individually and jointly through at least a portion of the display portions;
producing one or more operation parameters according to one or more touch operations; and
transmitting the one or more operation parameters to the display device to enable the display device to modify the one or more images according to the one or more operation parameters.

18. The computer program product of claim 17, wherein the step of displaying the GUI comprises:
displaying the GUI comprising the plurality of blocks arranged corresponding to the layout of the display portions in the display device with the display portions and selectively displaying the one or more images individually and jointly through at least a portion of the display portions, such that one or more of the blocks correspond to a display portion.
